(19) United States
(12) Patent Application Publication
(10) Pub. No.: US 2005/0177430 A1
(43) Pub. Date: Aug. 11, 2005

(54) Method of interactive advertising

(76) Inventor: Daniel Willis, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/055,064

(22) Filed: Feb. 11, 2005

Related U.S. Application Data
(60) Provisional application No. 60/543,266, filed on Feb. 11, 2004.

(51) Int. Cl. G06F 17/60

(52) U.S. Cl. 705/14

(57) ABSTRACT

A method of interactive advertising is provided, according to which the display of the interactive advertisement does not disturb an entertainment event during which the interactive advertisement is displayed. During a process of entertainment, the entertainment relating to an entertainment event other than an event centered around a shopping experience, an interactive advertisement for a product or service is displayed, and data indicating an interest relating to the advertised product or service are received and stored. Upon near completion of the entertainment event, an individual is provided with an indication of the interactively advertised product or service for which he ro she has expressed an interest. Further data are received from the individual relating to the interactively advertised product or service. In connection with the method for interactive advertising there is also provided a method for selling a product or service within an entertainment environment.

This application claims benefit from U.S. Provisional application 60/543,266 filed Feb. 11, 2004.

### FIELD OF THE INVENTION

The instant invention generally relates to the field of advertising, and more specifically to the field of interactive advertising, involving mutual action between consumers and producers.

### BACKGROUND OF THE INVENTION

With the advent of the World-Wide-Web, which by today has adopted the status of an omnipresent and ubiquitous medium, a new form of advertising has developed, the so-called Interactive Advertising (IA). IA is the paid and unpaid presentation and promotion of products, services and ideas by an identified sponsor through mediated processes involving mutual action between consumers and producers. Thus, IA is a step closer to real communications; it is bi-directional, personalized, and shifts control to the customers' side, which is the main paradigm shift from traditional advertising. Interactivity as such is not restricted to a “human-machine human” interaction, but may be construed as “human-machine-human”, “human-machine”, “human-message”, or “machine-machine” type interaction.

There are at least two parties involved in IA, consumers and companies, and optionally an agency takes on the role of a third party. The mutual action between producers and consumers implies a significantly increased role of consumers in the process. Consumers become more of active participants of advertising, rather than passive perceivers of messages sent to them. As active participants, consumers achieve power to influence the advertising process and its future development. Like in the traditional advertising process, agencies are intermediaries between the consumer and the company, but the peculiarity of an interactive process is that the agency has the control over the interactivity level and process. Also, there are new types of issues for the agency to deal with, such as new technology and creativity in new environment, as well as different types of competitors, amongst others. The key phrase “mutual action” affects the companies not less than consumers, and IA requires flexibility and coordination from the companies. In the age of integrated marketing communication, IA constitutes another possibility to reach consumers, with the inherent danger to loose costumers, if the strategic approach followed in IA does not satisfy costumers' expectation values.

A review of the current literature including the patent database of the United States Patent and Trademark Office reveals that a plurality of systems and methods has been devised, which exploit the aspect of interactive advertising. However, the systems and methods known in the art approach IA from a “machine-machine” based approach, or at best a “human-message” based approach, rather than putting the emphasis on the human component itself. Two examples will be sufficient to underline this point.

In U.S. Pat. No. 6,188,398 to Collins-Rector et al., issued Feb. 13, 2001, there is disclosed a method for enabling an interactive video experience utilizing the Internet in which entertainment is combined with advertising to create an enhanced advertising experience. The invention utilizes techniques to deliver demographically targeted advertisements at predetermined times while watching a video. In addition, selectable buttons are maintained in a visible stack, which, when selected, cause a window to be opened containing further information. In this manner, a user is able to select an object, and obtain more information about the selected object, while the video stream is still playing, as well as make a purchase decision.

In U.S. patent application No. 2002/0059590 to Kitsukawa et al., published May 16, 2002, there is disclosed a method according to which on-demand electronic advertising information is provided for items used in scenes of television programs. The advertising information is received along with broadcasts of associated television programs. Selected advertisement modes alert a viewer when advertising information is available for an item displayed in a scene of the television program broadcast. The viewer alert comprises displayed marks superimposed over the broadcast of the television program. The displayed marks comprise indicators for each item for which advertising data is available, and the indicators may be representative of the items to which the indicators correspond. The advertising information for a particular item is selected when the viewer selects the indicator corresponding to the item in which the viewer is interested. Upon selection, the advertising information is displayed along with the broadcast of the currently selected television program. The advertising information may be used to electronically order the associated item.

The “machine-machine” based approach is evident, as an advertisement is displayed as immediate response to a signal received. According to Collins-Rector et al., a user is able to select an object, and to obtain more information about the selected object, while the video stream is still playing. According to Kitsukawa et al., advertising information is displayed along with the broadcast. In both cases, information is displayed at the same time that a main event takes place, and little notion is taken how the display of selected information might possibly interfere with the user's degree of received pleasure while participating in the main event, like watching a video. It is likely that in many cases, the display of further information is received as disturbing, interfering, and bothersome, and the negative aspect of IA as outlined above, the danger of loosing costumers, becomes effective with all it consequences.

It would be advantageous to devise IA techniques, typically individually designed for given advertising scenarios and particular advertising environments, that following “human-machine-human” based approaches rather than “machine-machine” based approaches.

### SUMMARY OF THE INVENTION

It is an advantage of the instant invention that the customer reaction is registered, but not reacted to immediately. Instead, data corresponding to a customer's response is stored and corresponding action is taken at a later time, such that a main event a customer is immersed in is not disturbed. This outlines the “human-machine-human” approach to IA. A response from a human component is registered, the machine component stores the response and does not act immediately, but at a time accommodating needs of the human component, and once a response is issued and further data from the human component are received, the machine takes suitable action corresponding to the further data received.

It is a further advantage of the instant invention, that an approach is taken other than a “machine-machine” based approach, according to which intermediate replies to signals received are issued, possibly disturbing a main event the IA is embedded in.

In accordance with an aspect of the instant invention, there is provided a method of interactive advertising. During a process of entertainment, the entertainment relating to an entertainment event other than an event centered around a shopping experience, performed are the steps of displaying an interactive advertisement for a product or service, receiving from an individual participating in the entertainment event data indicating an interest relating to the advertised product or service, and storing the received data relating to the interactive advertisement for a product or service. The method further comprises the steps of upon near completion of the entertainment event, providing the individual with an indication of the interactively advertised product or service for which an indication of interest was received; and receiving from the individual further data relating to the interactively advertised product or service.

In accordance with another aspect of the instant invention, there is further provided a method for selling a product or service within an entertainment environment, the entertainment environment comprising a customer site, a vendor site, and an agency site, the method comprising the steps of displaying an interactive advertisement for a product or service during the display of an entertainment event within the entertainment environment; issuing a purchase order for an interactively advertised product or service from the customer site to the vendor site, paying a charge associated with the purchased product or service from the agency site to the vendor site, and paying a charge associated with the purchased product or service from the customer site to the agency site.

### BRIEF DESCRIPTION OF THE DRAWINGS

The instant invention is now described in conjunction with the following drawings, in which

FIG. 1 displays a flow diagram illustrating a prior art method of Interactive Advertising;

FIG. 2 displays a flow diagram illustrating a method of Interactive Advertising according to the instant invention;

FIG. 3 shows a schematic diagram of an entertainment environment; and

FIG. 4 shows a flow diagram for method for selling a product or service within an entertainment environment.

### DETAILED DESCRIPTION OF THE INVENTION

The instant invention is now described with reference to selected examples, in which the concept of interactive advertising (IA) according to the instant invention is beneficially employed. However, it is evident to a person of skill in the art that the detailed description provides illustrative examples only, and that the principle and underlying ideas are extended without difficulties to other areas in which interactive advertising (IA) is utilized, or which exhibit a potential for future use of IA.

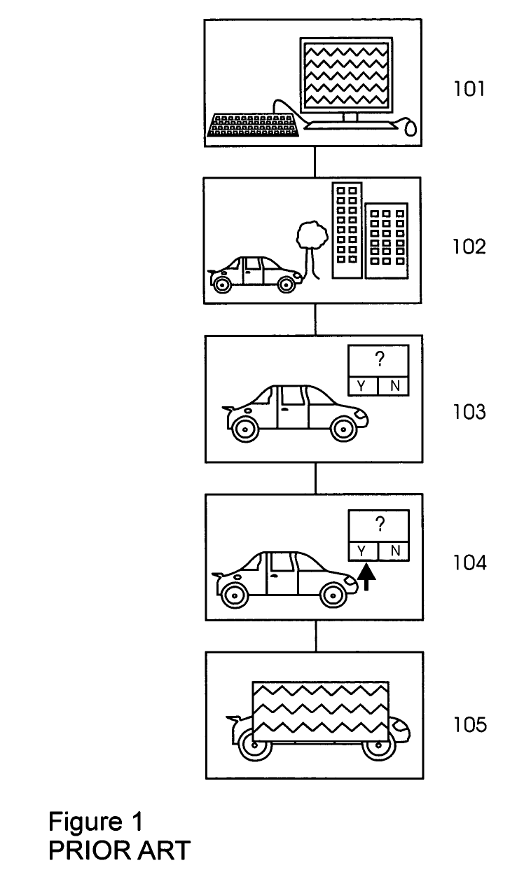

FIG. 1 shows a prior art example of IA, following a “machine-machine” (MM) based approached. An MM strategy is characterized by immediate responses to provided signals, without further analysis. In analogy to common computational techniques, an MM approach corresponds to the execution of a rigid program structure. This is in contrast to a “human-machine-human” (HMH) approach, which displays characteristics typically encountered in program structures following genetic algorithms.

The procedure displayed in FIG. 1 begins when an entertainment environment is provided, step 101, an entertainment environment typically contains an entertainment unit having a screen for displaying the entertainment, an audio system, and interactive devices such as keyboard, mouse, joystick, and the like. An entertainment system relates for example to the displays of videos, obtained from videotape, from DVD, from a wide area network, or from a satellite connection. An entertainment system might also relate to playing video games, the games again being received from either a video tape, a DVD, a wide area network, an internal computer storage medium, among others. In step 102, a user utilizes the entertainment environment, and initializes display of an entertainment event (EE). For example, a movie is displayed, or a video game is played. In IA, these entertainment events (EE) are typically set up such that interactive advertising is possible. For example, in step 103, an interactive image being part of the entertainment event appears on the screen. For such a particular image, additional information is available, and an interaction box is displayed, possibly utilized by the user to voice his or her opinion on further actions relating to the particular image. Typically, in AI, the decision of the user will trigger display of advertising information for the item shown in the particular image, or will enable a user to purchase the item shown. In step 104, the user is engaged in an interactive decision, responding to the popped up interaction box. For example, the user clicks into an affirmation field to express his interest in receiving more information on the item shown. In step 105, a response to the user's request is displayed. Additional information relating to the item is immediately provided, and typically interferes with the display of the entertainment event. This process is often repeated numerous times, and the constant interruption of an entertainment event (EE) disrupts a constant flow and the perceived experience of an EE. In view of IA, the EE appears distorted and diluted.

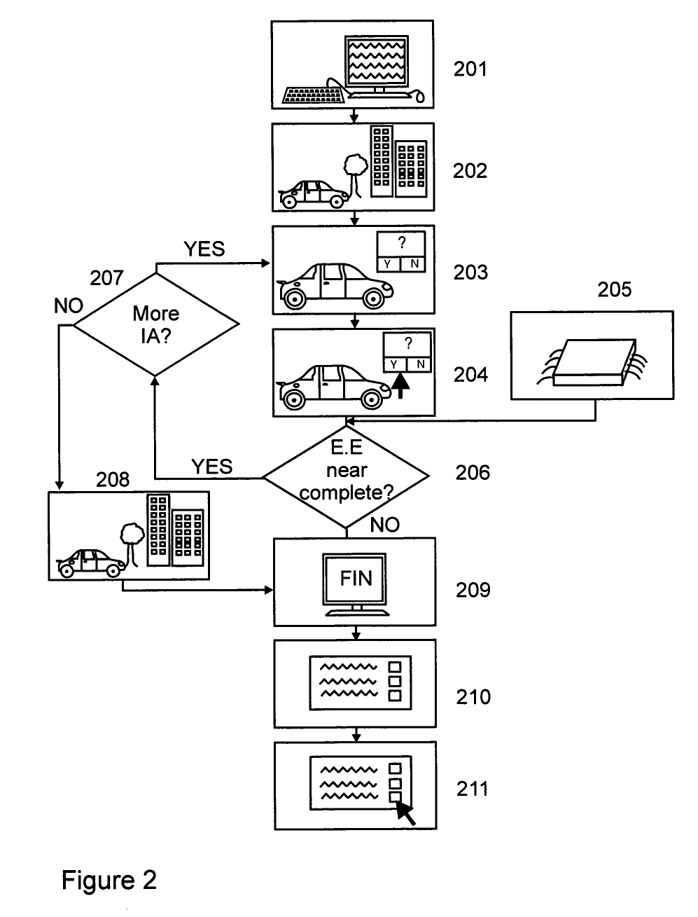

Referring now to FIG. 2, a flow diagram for method utilizing IA according to the instant invention is displayed. Steps 201, 202, 203, and 204 are similar to the corresponding steps 101, 102, 103, and 104, as described for FIG. 1, and relate to providing an entertainment environment, displaying an entertainment event (EE), displaying an interactive image, and expressing and receiving an interest from a user. Instead of immediately replying to the user's request, data relating to the user's interest, and/or the user's request are stored in a storage system, step 205. The storage system is typically part of the entertainment environment. In step 206, it is determined whether the entertainment event has reached a state of “near completion”. A state of near completion is a state in which the entertainment event has reached a phase in which display of an advertisement is not likely to disturb the viewer. The state of near completion is, in general, user dependent; and various methods exist to define a state of near completion. Such methods contain either a step of specifying user specific parameters before the EE is executed, by evaluating a user specific profile, or by other suitable means following similar strategies. If the EE has not reached a state of near completion, it is decided in step 207, whether another interactive advertisement is to be embedded into the EE. If yes, the procedure steps back to step 203. If it is decided that no other IA is to be displayed, the EE continues without any more IA, step 208, and reaches a state of near completion, 209. Once a state of near completion is reached, the data stored in relation to an interest issued by the user are presented to the user, step 210. Typically the data are presented in such a way that additional data relating to the selected information are to be entered. In step 211, the user selects and enters further data relating to the image selected while the EE was displayed. According to the method as outlined in FIG. 2, the display of IA does not significantly interfere with the presentation of the entertainment event. According to the IA classification as outlined above, the method according to the instant invention provides advantages both for consumers as well as companies. Consumers enjoy an undisturbed presentation of an EE, while at the same time being able to receive additional information on a product that spawned their interest when taking pleasure in the entertainment event. Companies have a suitable vehicle for providing advertisement without running the risk that the display of advertisements will negatively affect the number of costumers. On the contrary, it is to be expected that such a concept of IA is likely to increase the number of costumers associated with a certain company, since many customers enjoy the possibility to instantly react to certain desires created, and to instantly satisfy their wishes. This way, another degree of satisfaction is added to the EE, which is likely to be appreciated by a plurality of independent customers.

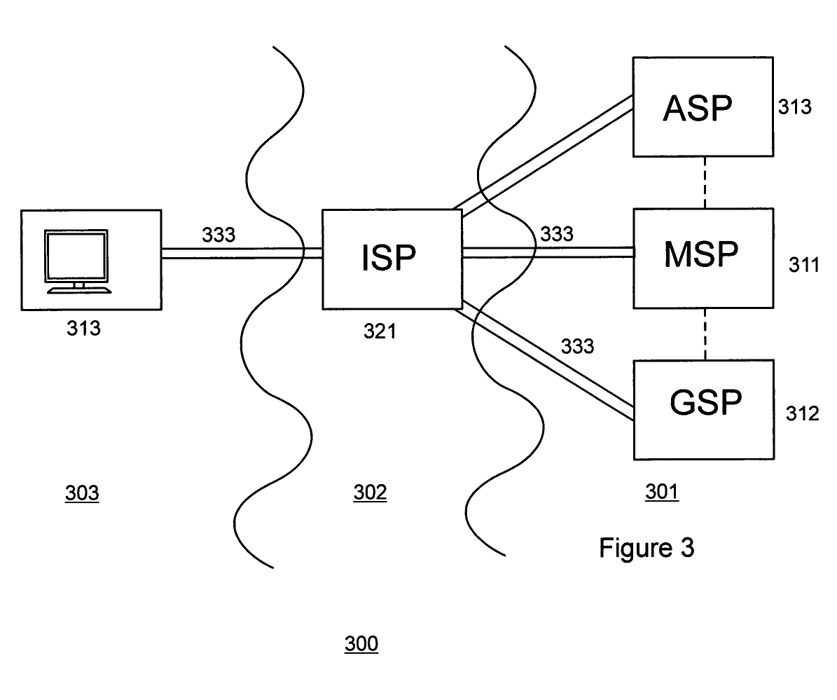

Referring now to FIG. 3, a schematic diagram of an entertainment environment for interactive advertising 300 is shown. In this example, the EE is based on components linked by and in communication with each other through a wide area network (WAN) 333. As outlined above for IA, parties involved in IA are a company site 301, an agency site 302, and a consumer site 303. Here, the company site contains a movie service provider (MSP) 311, a gaming service provider (GSP) 312, and an advertisement service provider (ASP) 313. Typically, the MSP 311 provides a video entertainment event, and the GSP 312 provides a gaming entertainment event. The ASP 313 provides interactive advertisements to be displayed during the EE. Other sites being part of the company site are possibly envisioned. Typically, the different components on the company site are in contact and in communication with each other. Services provided by the ASP 313 are such that they are compatible with entertainment events provided by the MSP 311 or the GSP 312.

In the entertainment environment for interactive advertising 300 an Internet service provider 321 takes on the role as an agency. However, the main role of the ISP 321 is that of an intermediary between the consumer site 303 and the company site 301.In the case of this particular example, the agency has only limited control over the interactivity level and process. On the consumer site 303, there is typically located an entertainment unit having a screen for displaying the entertainment, an audio system, and interactive devices such as keyboard, mouse, joystick, and the like.

In many cases, the different sites at the company site appear on different virtual sites, but are stored on an identical physical site. A MSP 311 might integrate the service of an ASP 313. In this case, the interactive advertisement is preferably presented in form of product placement. Also, the different sites 301, 302, and 303 are possibly in contact with other sites outside the entertainment environment for interactive advertising 300, the contact established via a network (not shown).

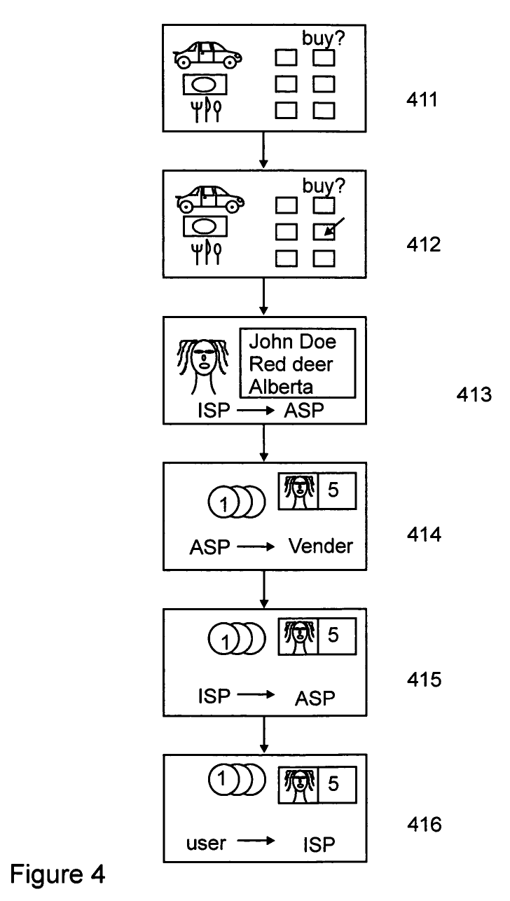

Although the ISP as agency site in many cases is not involved in an interactive process, there exist different scenarios in which the ISP plays a vital role in the interactive process. Such an example is illustrated in reference to FIG. 4. In step 411, an indication of displayed or advertised products, for which a user has expressed a certain interest, is provided to the user. This step is closely related to step 211 of the method illustrated in FIG. 2. Typically, when providing these data to the user, one or more decision fields accompany the data. In the present example the decision field relates to buying a particular product. The user is presented with detailed information for the particular product, and makes a decision whether or not he wants to buy the particular product. If the user decides to purchase the particular product, the related decision field is selected and data according to the user's decision are transmitted to the ASP site 313, step 412. The ASP site 313 is not only in communication with the ISP site 321, but also with a vendor site. In one embodiment of the instant invention, the vendor site is not part of the entertainment environment for interactive advertising 300. In another embodiment f the instant invention, the vendor site is part of the company site 301 of the IA environment. The ISP site 321 knows the user associated with this order, for example by resolving a physical port from which a certain order was placed. The ASP site 313 requests and receives from the ISP site 321 information related to the user ordering a particular product, step 413. This information contains an address to which the purchased product is to be delivered. The ASP site 313 pays a corresponding charge to the vendor site, and passes the related user information to the vendor site, step 414. The ASP site 313 also charges the ISP site for the order placed by the user, step 415. The ISP site 321 in turn adds the charge for the product to the user's bill for ISP services, step 416. This method of ordering is advantageous, since it not only simplifies the shopping process related to IA, and creates a user friendly only shopping experience, but also provides an extra measure of security for the user, who is not requested to surrender confidential information such as her or his credit card number to a potentially insecure environment.

Whereas the example described above relates to a particular product advertised with IA, the advertisement of a service can also be envisioned. For example, hotels might provide IA on their in house video channels for escort services. Many other services lend themselves beneficially to IA.

Although embodiments of the invention have been described above, it is not limited thereto, and it will be apparent to persons skilled in the art that numerous modifications and variations form part of the present invention as so far as they do not depart form the spirit, nature and scope of the claimed and described invention.

1. A method of interactive advertising comprising the steps of
(a) during a process of entertainment, the entertainment relating to an entertainment event other than an event centered around a shopping experience, performing the steps of:
(a1) displaying an interactive advertisement for a product or service;
(a2) receiving from an individual participating in the entertainment event data indicating an interest relating to the advertised product or service;
(a3) storing the received data relating to the interactive advertisement for a product or service;
(b) upon near completion of the entertainment event, providing the individual with an indication of the interactively advertised product or service for which an indication of interest was received; and
(c) receiving from the individual further data relating to the interactively advertised product or service.

2. A method according to claim 1, wherein the further data relates to a request for further advertising information relating to the product or service.

3. A method according to claim 1, wherein the further data relates to confirmation of interest in the product or service.

4. A method according to claim 3, wherein the further data relates to purchasing of the product or service.

5. A method according to claim 1, wherein the entertainment event is a video entertainment event.

6. A method according to claim 5, wherein the video entertainment event is display of a motion picture.

7. A method according to claim 6, wherein the interactive advertisement is in the form of a product placement.

8. A method according to claim 5, wherein the video entertainment event is a video game

9. A method according to claim 5, wherein the interactive advertisement is a commercial advertisement interrupting the video entertainment event.

10. A method according to claim 5, wherein the further data are received from the individual are received upon or after near completion of the video entertainment event.

11. A method according to claim 5, wherein the further data are received from the individual before near completion of the video entertainment event.

12. A method for selling a product or service within an entertainment environment, the entertainment environment comprising a customer site, a vendor site, and an agency site, comprising the steps of:
(a) displaying an interactive advertisement for a product or service during the display of an entertainment event within the entertainment environment;
(b) issuing a purchase order for the interactively advertised product or service from the customer site to the vendor site;
(c) paying a charge associated with the purchased product or service from the agency site to the vendor site; and
(d) paying a charge associated with the purchased product or service from the customer site to the agency site.

13. A method according to claim 12, wherein the agency site is an Internet service provider.

14. A method according to claim 12, wherein the product or service related to a product or service advertised in an interactive advertisement during the display of a video entertainment event.

15. A method according to claim 14, wherein the video event is display of a motion picture.

16. A method according to claim 15, wherein the interactive advertisement is in the form of a product placement.

17. A method according to claim 14, wherein the video entertainment event is a video game

18. A method according to claim 14, wherein the interactive advertisement is a commercial advertisement interrupting the video entertainment event.
